(19) United States
(12) Patent Application Publication
(10) Pub. No.: US 2015/0197663 A1
(43) Pub. Date: Jul. 16, 2015

(54) SELF-ORGANIZING COMPOSITION FOR FORMING PATTERN, METHOD FOR FORMING PATTERN BY SELF-ORGANIZATION OF BLOCK COPOLYMER USING SAME, AND PATTERN

(71) Applicant: FUJIFILM Corporation, Tokyo (JP)

(72) Inventors: Kazuyoshi MIZUTANI, Haibara-gun (JP); Tsukasa YAMANAKA, Haibara-gun (JP)

(73) Assignee: FUJIFILM CORPORATION, Tokyo (JP)

(21) Appl. No.: 14/669,327

(22) Filed: Mar. 26, 2015

Related U.S. Application Data
(63) Continuation of application No. PCT/JP2013/075938, filed on Sep. 25, 2013.

(30) Foreign Application Priority Data
Sep. 28, 2012 (JP) 2012-217567

(51) Int. Cl. C09D 153/00; B05D 3/02; B05D 3/10; B05D 1/00

(52) U.S. Cl. CPC C09D 153/00; B05D 1/005; B05D 3/0254; B05D 3/107

(57) ABSTRACT

There is provided a pattern forming method through self-organization of a block copolymer, containing an annealing step after application of a self-organizing composition for forming pattern that contains a block copolymer containing a block having a repeating unit represented by the specific general formula, and contains an organic solvent, to a substrate, and wherein after a microphase-separated structure is formed in the annealing step, one domain thereof is selectively removed to form a pattern.

### CROSS REFERENCE TO RELATED APPLICATION

This is a continuation of International Application No. PCT/JP2013/075938 filed on Sep. 25, 2013, and claims priority from Japanese Patent Application No. 2012-217567 filed on Sep. 28, 2012, the entire disclosures of which are incorporated therein by reference.

### TECHNICAL FIELD

The present invention relates to a self-organizing composition of a resist composition for forming pattern, which is applicable to a process for semiconductor production for ICs and others, to production of circuit boards for liquid crystals, thermal heads and others, to formation of stampers for bit patterned media for hard disc drives, and further to a process of lithography for other photo fabrication and the like, to a patterning method through self-organization of a block copolymer using the self-organizing composition, and to a pattern.

### BACKGROUND ART

Recently, ultra-micropatterning has been promoted with advance in high-density integrated circuits, and development of microfabrication technology by lithography using ArF excimer laser light as well as other radiations such as EUV light, electronic beams and X ray has been promoted, which, however, involves a problem of process cost increase, and consequently, development of any other patterning technology not using photolithography such as development of nanoimprinting or self-organization lithography that utilizes microphase separation of a block copolymer (hereinafter this may be simply referred to as “block copolymer”) has also been promoted.

On the other hand, with advance in high-density recording on hard disc drives, development of technology for bit patterned media of fabricating magnetic films into sizes of different bits is being promoted. For example, for realizing a recording density of ST bit/inch, formation of about 12-nm ultra-microdot patterning is required, in which development of self-organization lithography using microphase separation of a block copolymer is also being promoted.

Various processes have been proposed for self-organization lithography. For example, for controlling the configuration and the alignment of a self-organized nanostructure formed through microphase separation, there are proposed a graphoepitaxy process of controlling a microphase separation pattern according to the guide pattern provided on the base substrate to which a block copolymer is applied, and a chemical registration process of controlling a microphase separation pattern depending on the difference in the chemical properties of the substrate surface.

In self-organization lithography, a self-organizing resist film that contains a block copolymer is formed on the substrate on which a guide pattern has been provided as above, then a microphase separation structure is formed in a solvent atmosphere or through annealing treatment by heating, and thereafter a specific block of the block copolymer is selectively removed for patterning through oxygen plasma treatment, ozone treatment, UV irradiation treatment, thermal decomposition treatment or chemical decomposition treatment.

As the block copolymer for use in the patterning method through self-organization, usable is a copolymer having two or more segments capable of mutually inducing microphase separation. In the block copolymer, for example, advantageously used are blocks that differ in the numeral value of the Flory-Huggins interaction parameter, for realizing microphase separation. There are reported a large number of such block copolymers, such as a block copolymer of polystyrene and polymethyl methacrylate, as well as a block copolymer of polystyrene and polydimethylsiloxane, a block copolymer of polyethylene oxide and polymethyl methacrylate (for example, see Patent Document 1 and Non-Patent Document 1).

### RELATED ART

### Patent Document

Patent Document 1: JP-A 2012-61531

### Non-Patent Document

Non-Patent Document 1: S. O. Kim, et al., Epitaxial Selfassembly of Block Copolymers on Lithographically Defined Nanopatterned Substrates, Nature, 2003, 424, 411

### SUMMARY OF THE INVENTION

### Problems that the Invention is to Solve

However, the pattern forming method through self-organization using a block copolymer mentioned above takes an extremely long time of around 24 hours for annealing for self-organization or microphase separation to be applied to the self-organizing resist film that contains a block copolymer, which is a significant bar to application of the method to a process for semiconductor production that requires a high throughput (productivity).

An object of the present invention is to provide a self-organizing composition for forming pattern, which can extremely shorten the annealing time necessary for microphase separation in self-organization lithography using a block copolymer and which can therefore improve the throughput in patterning, to provide a pattern forming method through self-organization of a block copolymer using the composition, and to provide a pattern.

### Means for Solving the Problems

The present inventors have found that, using a block copolymer having a specific structure makes it possible to shorten the annealing time necessary for microphase separation through self-organization and therefore to improve the throughput in a process of semiconductor production.

On the basis of the above-mentioned findings, the inventors have achieved the present invention.

<1> A pattern forming method through self-organization of a block copolymer, containing an annealing step after application of a self-organizing composition for forming pattern that contains a block copolymer containing a block having a repeating unit represented by the following general formula (1), and contains an organic solvent, to a substrate, and

wherein after a microphase-separated structure is formed in the annealing step, one domain thereof is selectively removed to form a pattern:

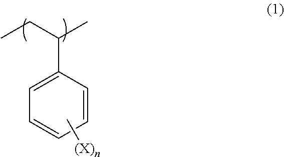

in the above general formula (1);

X represents an alkyl group or a cycloalkyl group;

n indicates an integer of from 1 to 5, and when n is 2 or more, X's may be the same or different.

<2> The pattern forming method through self-organization of a block copolymer as described in <1>,

wherein the block copolymer further contains a block having a repeating unit represented by the following general formula (2):

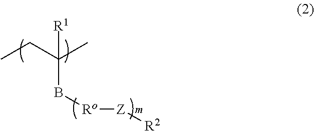

in the above general formula;

R¹ represents a hydrogen atom, a cyano group, a halogen atom or an alkyl group;

B represents an ester bond or an amide bond;

R⁰ or R⁰'s when a plurality of R⁰'s are present, each independently represent an alkylene group, a cycloalkylene group or a combination thereof;

Z or Z's when a plurality of Z's are present, each independently represent a single bond, an ether bond, an ester bond, an amide bond, an urethane bond or an urea bond;

m represents a repeating number of the structure represented by —R⁰—Z—, and indicates an integer of from 0 to 5; when m is 0, then the formula does not have —R⁰—Z— but has a single bond;

R² represents a group having a lactone structure, a group having a sultone structure, a cyclic hydrocarbon group having an ether bond, or an alkyl group having 3 or less carbon atoms.

<3> The pattern forming method through self-organization of a block copolymer as described in <1> or <2>,

wherein the block copolymer further contains a block having a repeating unit with an alkylene oxide chain or an aliphatic ester chain as the main chain thereof.

<4> The pattern forming method through self-organization of a block copolymer as described in any one of <1> to <3>,

wherein the a self-organizing composition for forming pattern further contains a fluorosurfactant or a silicone surfactant.

<5> The pattern forming method through self-organization of a block copolymer as described in <1>,

wherein the substrate is a substrate wherein, on the surface thereof, an underlayer having a guide pattern that controls the alignment of the self-organization of the block copolymer is provided.

<6> A pattern formed by the patterning method through self-organization of a block copolymer described in any one of <1> to <5>.
<7> A method for producing an electronic device, containing the pattern forming method through self-organization of a block copolymer described in any one of <1> to <5>.
<8> An electronic device produced by the method for producing an electronic device described in <7>.

The present invention relates to the above-mentioned <1> to <8>, but for reference, also described herein are other matters (for example, the matters described in the following [1] to [9].

[1] A self-organizing composition for forming pattern, containing:

a block copolymer containing a block having a repeating unit represented by the following general formula (1); and

an organic solvent:

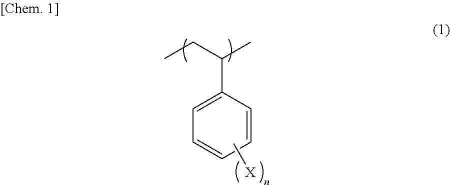

in the above general formula (1);

X represents an alkyl group or a cycloalkyl group;

n indicates an integer of from 1 to 5, and when n is 2 or more, X's may be the same or different.

[2] The self-organizing composition for forming pattern as described in [1],

wherein the block copolymer further contains a block having a repeating unit represented by the following general formula (2):

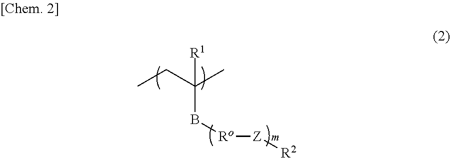

in the above general formula;

R¹ represents a hydrogen atom, a cyano group, a halogen atom or an alkyl group;

B represents an ester bond or an amide bond;

R⁰ or R⁰'s when a plurality of R⁰'s are present, each independently represent an alkylene group, a cycloalkylene group or a combination thereof;

Z or Z's when a plurality of Z's are present, each independently represent a single bond, an ether bond, an ester bond, an amide bond, an urethane bond or an urea bond;

m represents a repeating number of the structure represented by —R⁰—Z—, and indicates an integer of from 0 to 5; when m is 0, then the formula does not have —R⁰—Z— but has a single bond;

R² represents a group having a lactone structure, a group having a sultone structure, a cyclic hydrocarbon group having an ether bond, or an alkyl group having 3 or less carbon atoms.

[3] The self-organizing composition for forming pattern as described in [1] or [2],

wherein the block copolymer further contains a block having a repeating unit with an alkylene oxide chain or an aliphatic ester chain as the main chain thereof.

[4] The self-organizing composition for forming pattern as described in any one of [1] to [3], which further containing a fluorosurfactant or a silicone surfactant.
[5] A pattern forming method through self-organization of a block copolymer, containing an annealing step after application of the self-organizing composition for forming pattern as described in any one of [1] to [4], to a substrate.
[6] The pattern forming method through self-organization of a block copolymer as described in [5],

wherein the substrate is a substrate wherein, on the surface thereof, an underlayer having a guide pattern that controls the alignment of the self-organization of the block copolymer is provided.

[7] A pattern formed by the patterning method through self-organization of a block copolymer described in [5] or [6].
[8] A method for producing an electronic device, containing the pattern forming method through self-organization of a block copolymer described in [5] or [6].
[9] An electronic device produced by the method for producing an electronic device described in [8].

### Advantage of the Invention

According to the present invention provides, there can be provided a self-organizing composition for forming pattern, which can extremely shorten the annealing time necessary for microphase separation in self-organization lithography using a block copolymer and which can therefore improve the throughput in patterning, as well as a pattern forming method through self-organization of a block copolymer using the composition, and a pattern.

### MODE FOR CARRYING OUT THE INVENTION

Regarding the expression of group (atomic group) in this description, the expression not indicated relative to substitution or unsubstitution is meant to include both one having no substituent and one having a substituent. For example, “alkyl group” includes not only an alkyl group not having a substituent (unsubstituted alkyl group) and an alkyl group having a substituent (substituted alkyl group).

In this description, “(meth)acrylate” means acrylate and methacrylate; “(meth)acryl” means acryl and methacryl; and “(meth)acryloyl” means acryloyl and methacryloyl.

In the present invention, “self-organization” means that molecules of a block copolymer and the like aggregate or organize to thereby autonomously form a high-order structure (regular domain or the like).

In the present invention, “microphase separation” means a phenomenon that a block copolymer forms a nanometer-order regular domain (lamella structure, dot structure, cylinder structure or the like) through self-organization, by which the shape, the size and the like of a pattern can be controlled through planning the molecular structure, the molecular weight or the like of a block copolymer.

In the present invention, “annealing” means a step of promoting microphase separation through self-organization of a block copolymer, which can be attained according to a step of exposure to an organic solvent atmosphere or by heating.

The self-organizing composition for patterning of the present invention contains a block copolymer containing a block having a repeating unit represented by the following general formula (1), and contains an organic solvent.

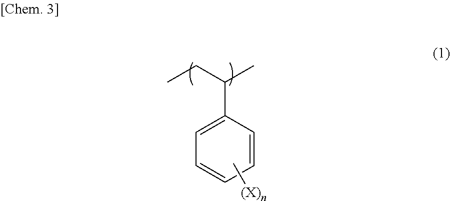

In the above general formula (1);

X represents an alkyl group or a cycloalkyl group.

The alkyl group for X may have a substituent, and is preferably an alkyl group having from 1 to 8 carbon atoms, more preferably a methyl group, an ethyl group, an n-propyl group, an i-propyl group, an n-butyl group, an i-butyl group, a t-butyl group, an n-amyl group, an i-amyl group, a t-amyl group, an n-hexyl group, an n-octyl group, a 2-ethylhexyl group, etc.

The cycloalkyl group for X is preferably a cycloalkyl group having from 3 to 8 carbon atoms, and includes a cyclopropyl group, a cyclobutyl group, a cyclopentyl group, a cyclohexyl group, etc. Above all, X is preferably a methyl group, an i-propyl group, a t-butyl group or a cyclohexyl group.

The substituent that the alkyl group or the cycloalkyl group may have includes a fluorine atom, a chlorine atom, a bromine atom, a hydroxyl group, an alkoxy group, an alkylcarbonyloxy group, an aryloxy group, an arylcarbonyloxy group, etc. Above all, preferred is a fluorine atom, a chlorine atom, a hydroxyl group, an alkoxy group or an alkylcarbonyloxy group.

n indicates an integer of from 1 to 5. When n is 2 or more, X's may be the same or different. n is preferably an integer of from 1 to 3.

The block copolymer containing a block having a repeating unit represented by the above-mentioned general formula (1) is preferably at least a binary or more polynary block copolymer, and may be, for example, a ternary block copolymer.

Though not clear, the reason why the self-organizing composition for patterning of the present invention can extremely shorten the annealing time necessary for microphase separation and can improve the throughput in patterning could be presumed as follows.

In the above general formula (1), the benzene ring of styrene has a specific substituent, and therefore would lower the interaction between the repeating units represented by the general formula (1) (so-called styrene units), and consequently, the mobility of the copolymer chain in annealing could be thereby increased and the time necessary for orientation in self-organization or in microphase separation could be thereby shortened.

Specific examples of the repeating unit represented by the above general formula (1) are shown below, to which, however, the invention is not limited thereto.

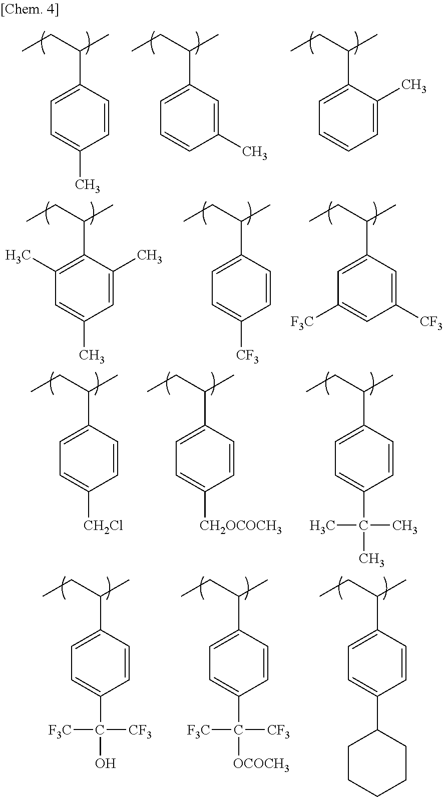

Preferably, the block copolymer for use in the present invention further contains a block having a repeating unit represented by the following general formula (2).

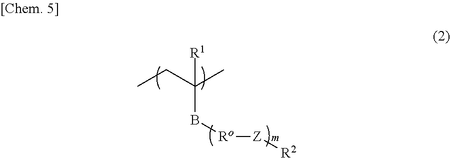

In the above general formula (2);

R¹ represents a hydrogen atom, a cyano group, a halogen atom or an alkyl group.

The alkyl group for R¹ is preferably an alkyl group having from 1 to 4 carbon atoms, more preferably a methyl group or an ethyl group, and even more preferably a methyl group.

B represents an ester bond (a group represented by —COO—) or an amide bond (a group represented by —CONH—).

R⁰ or R⁰'s when a plurality of R⁰'s are present, each independently represent an alkylene group, a cycloalkylene group or a combination thereof.

The alkylene group for R⁰ is preferably a linear alkylene group having from 1 to 10 carbon atoms, more preferably having from 1 to 5 carbon atoms, and includes, for example, a methylene group, an ethylene group, a propylene group, etc. The cycloalkylene group is preferably a cycloalkylene group having from 3 to 20 carbon atoms, and includes, for example, a cyclohexylene group, a cyclopentylene group, a norbornylene group, an adamantylene group, etc. For effectively expressing the advantageous effects of the present invention, more preferred is a linear alkylene group, and even more preferred is a methylene group.

Z or Z's when a plurality of Z's are present, each independently represent a single bond, an ether bond, an ester bond, an amide bond, an urethane bond or an urea bond.

Z is preferably an ether bond or an ester bond, more preferably an ester bond.

m represents a repeating number of the structure represented by —R⁰—Z—, and indicates an integer of from 0 to 5, but is preferably 0 or 1. When m is 0, then the formula does not have —R⁰—Z— but has a single bond in place of it.

When m is 0 and B is an amide bond, then the B and R² may form a cyclic hydrocarbon group having an ether bond.

The alkylene group and the cycloalkylene group for R⁰ and the alkyl group for R′ each may be substituted, and the sub stituent includes, for example, a halogen atom such as a fluorine atom, a chlorine atom, a bromine atom, etc., a mercapto group, a hydroxyl group, an alkoxy group such as a methoxy group, an ethoxy group, an isopropoxy group, a t-butoxy group, a benzyloxy group, etc., an acyloxy group such as an acetyloxy group, a propionyloxy group, etc.

R¹ represents a hydrogen atom, a methyl group, a trifluoromethyl group or a hydroxymethyl group.

R² represents a group having a lactone structure, a group having a sultone structure, a cyclic hydrocarbon group having an ether bond, or an alkyl group having 3 or less carbon atoms.

The lactone structure may be any structure having a lactone structure. Preferred is a 5- to 7-membered lactone structure. The 5- to 7-membered lactone structure may be condensed with any other cyclic structure to form a bicyclo structure or a spiro structure. Preferred is use of a repeating unit having a lactone structure represented by any of the following general formulae (LC1-1) to (LC1-17). The lactone structure may directly bond to the main chain of the polymer. Preferred lactone structures are (LC1-1), (LC1-4), (LC1-5), (LC1-6), (LC1-13), (LC1-14) and (LC1-17). The lactone structure (LC1-1) is especially preferred.

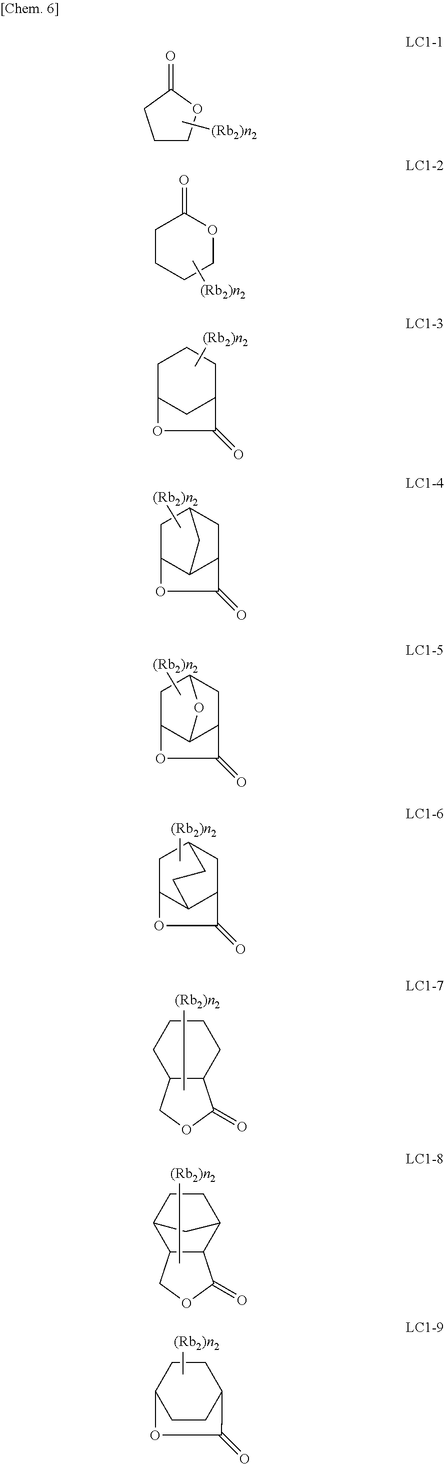

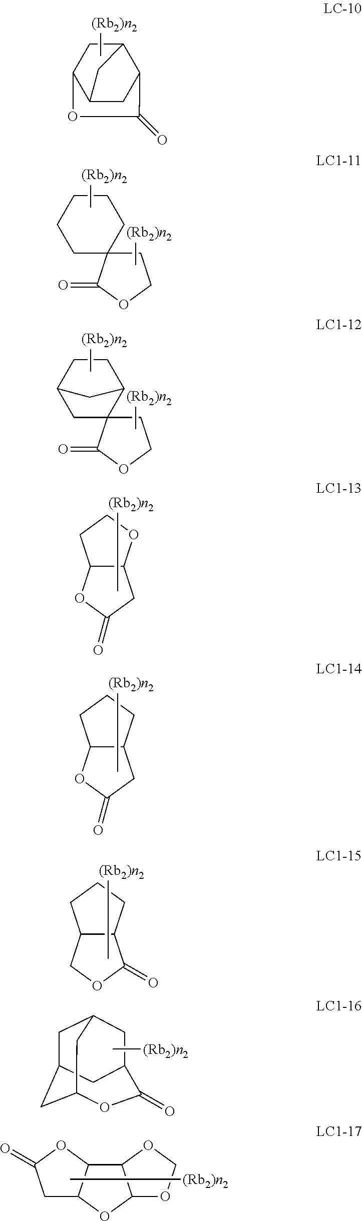

The lactone structure moiety may have or may not have a substituent (Rb₂). Preferred examples of the substituent (Rb₂) include an alkyl group having from 1 to 8 carbon atoms, a cycloalkyl group having from 4 to 7 carbon atoms, an alkoxy group having from 1 to 8 carbon atoms, an alkoxycarbonyl group having from 2 to 8 carbon atoms, a carboxyl group, a halogen atom, a hydroxyl group, a cyano group, etc. More preferred are an alkyl group having from 1 to 4 carbon atoms, and a cyano group. n₂ indicates an integer of from 0 to 4. When n₂ is 2 or more, plural substituents (Rb₂)'s may be the same or different. Also the plural substituents (Rb₂)'s may bond to each other to form a ring.

When R² is a group having a lactone structure, R² is preferably a group having an unsubstituted lactone structure, or a group having a lactone structure having, as a substituent, a methyl group, a cyano group or an alkoxycarbonyl group, and is more preferably a group having a lactone structure having a cyano group as a substituent (cyanolactone).

Specific examples of the repeating unit of the above-mentioned general formula (2) where R² is a group having a lactone structure are shown below, to which, however, the invention is not limited.

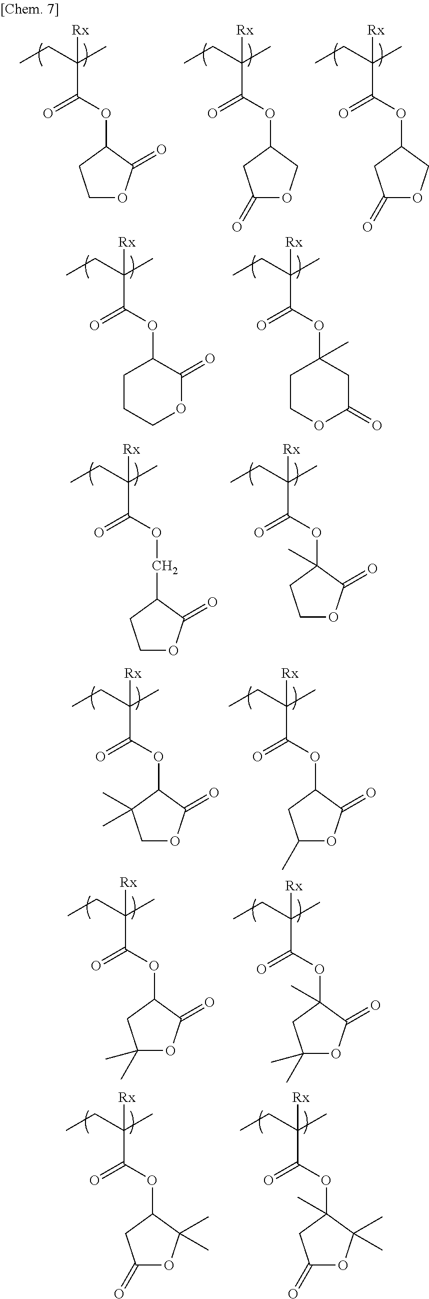

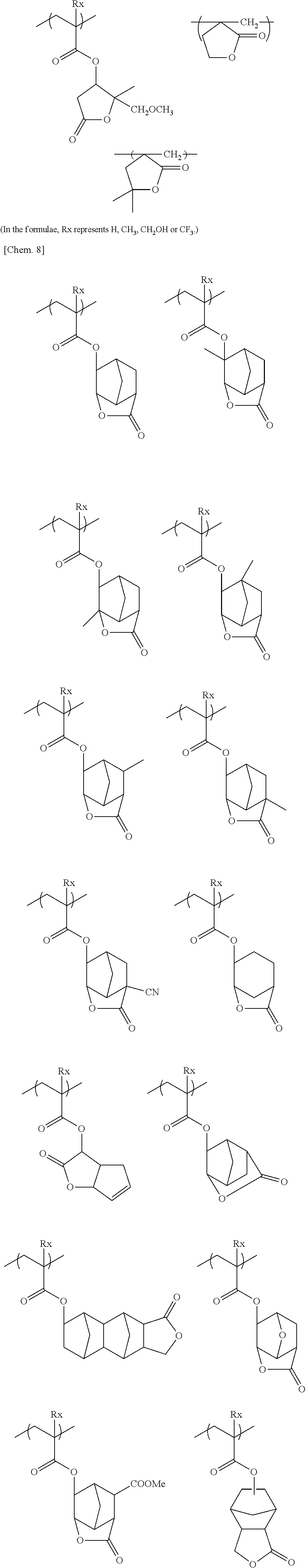

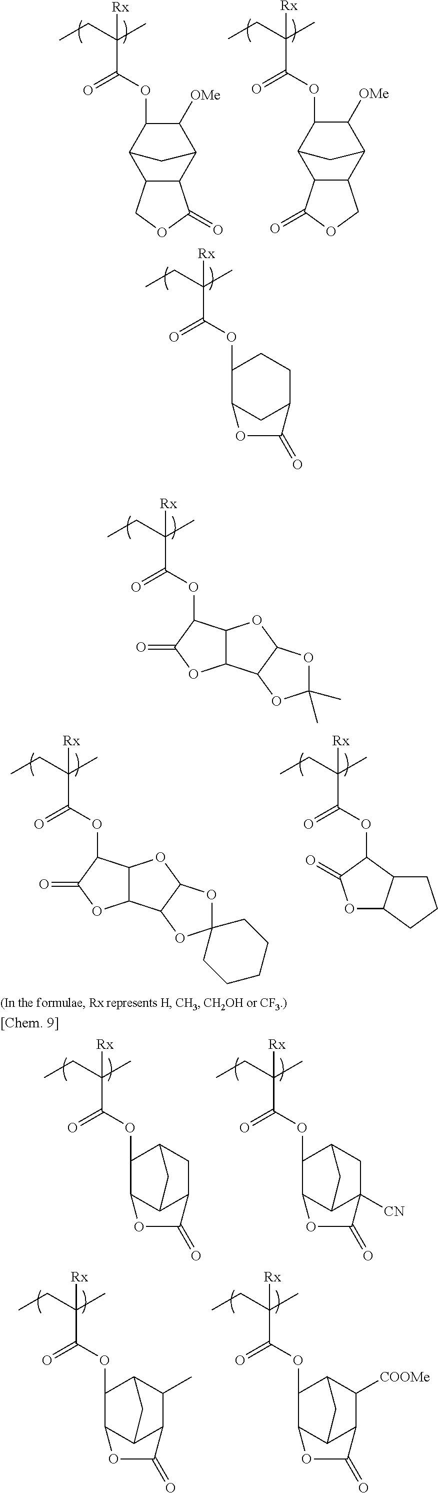

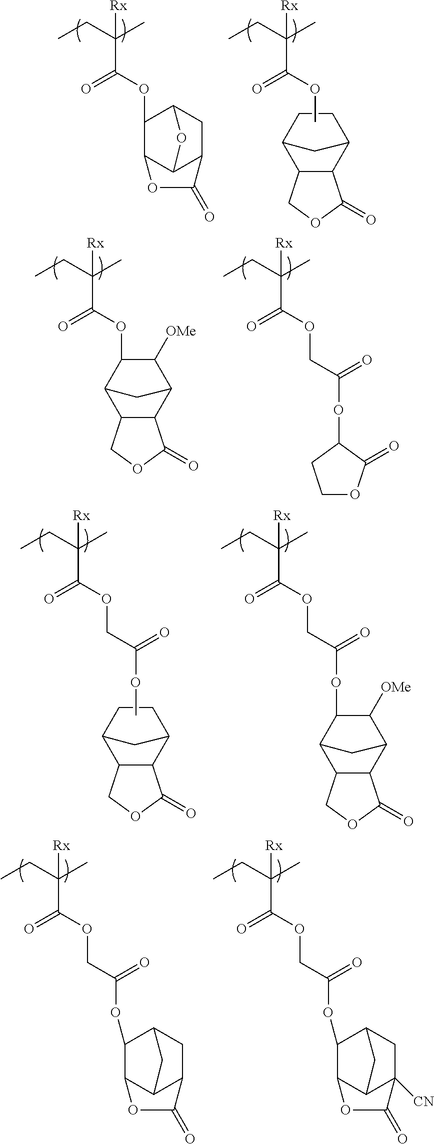

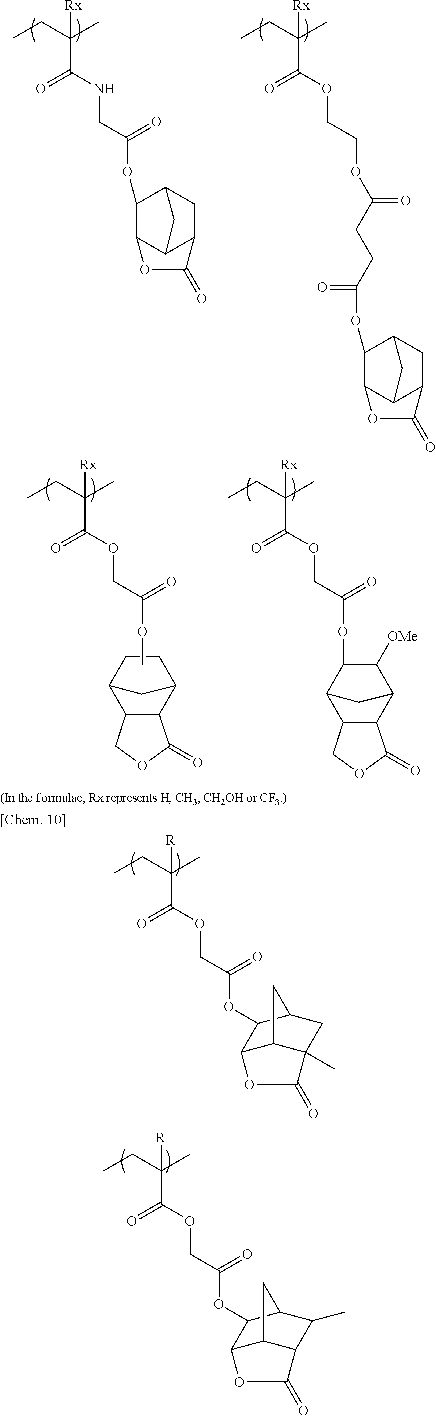

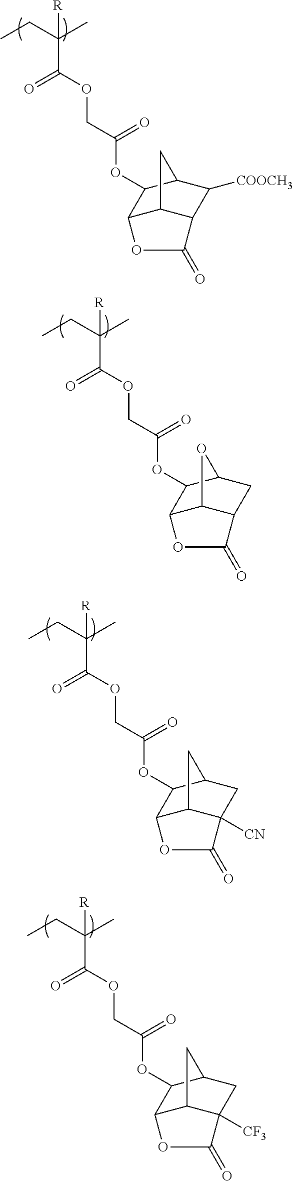

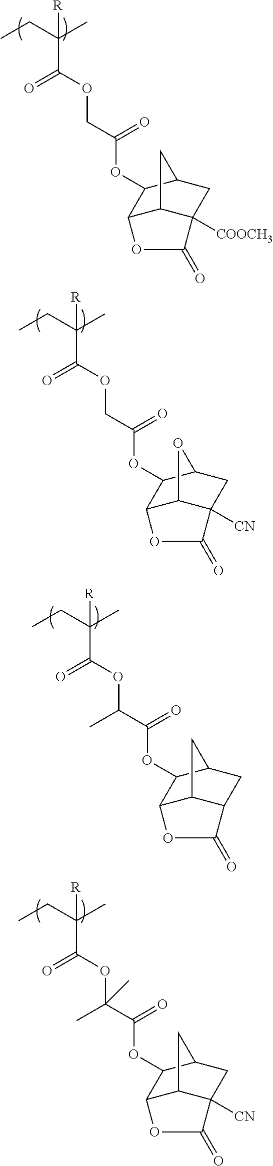

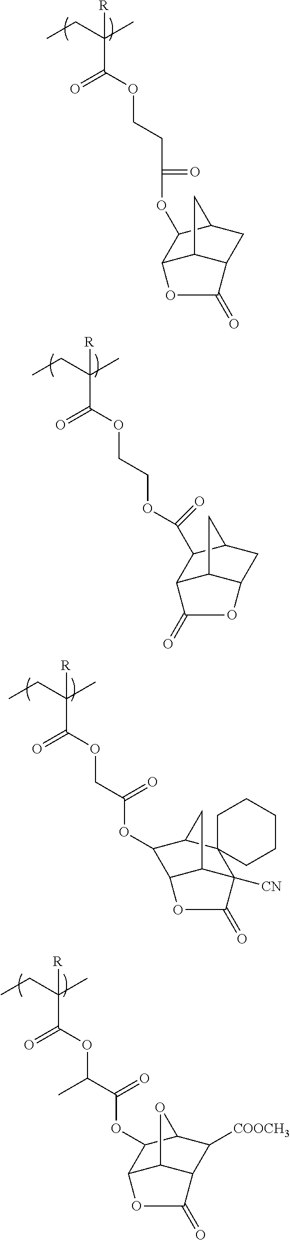

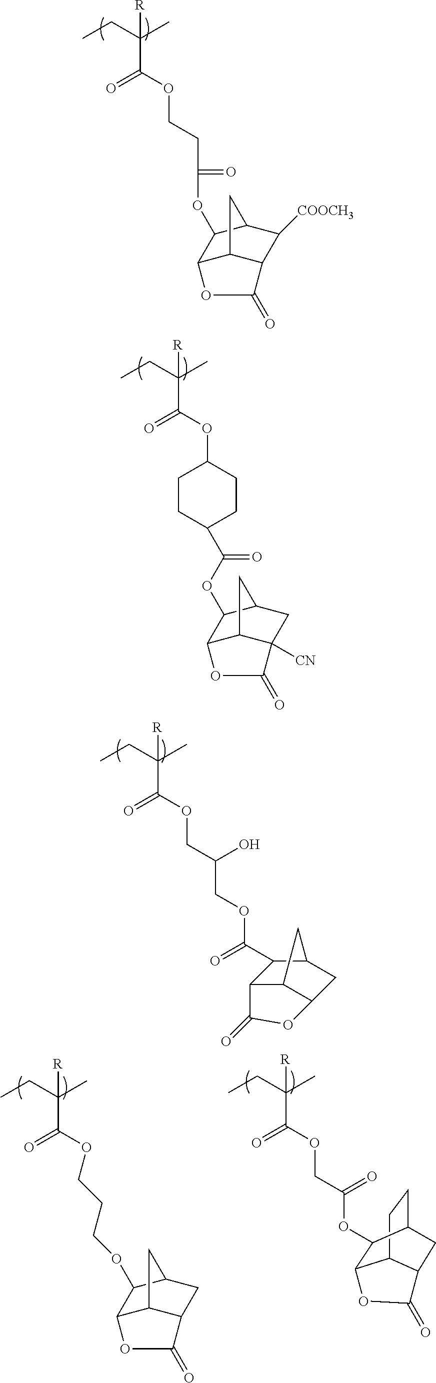

In the above formulae, R represents H, CH₃, CH₂OH or CF₃.

The cyclic hydrocarbon group having an ether bond for R² in the above general formula (2) is preferably a cyclic structure having from 3 to 6 carbon atoms, more preferably a cyclic structure having 3 or 4 carbon atoms. The cyclic structure may be condensed with any other cyclic structure to form a bicyclo structure or a spiro structure.

Specific examples of the repeating unit represented by the above general formula (2) where R² is a cyclic hydrocarbon group having an ether bond are shown below, to which, however, the present invention is not limited.

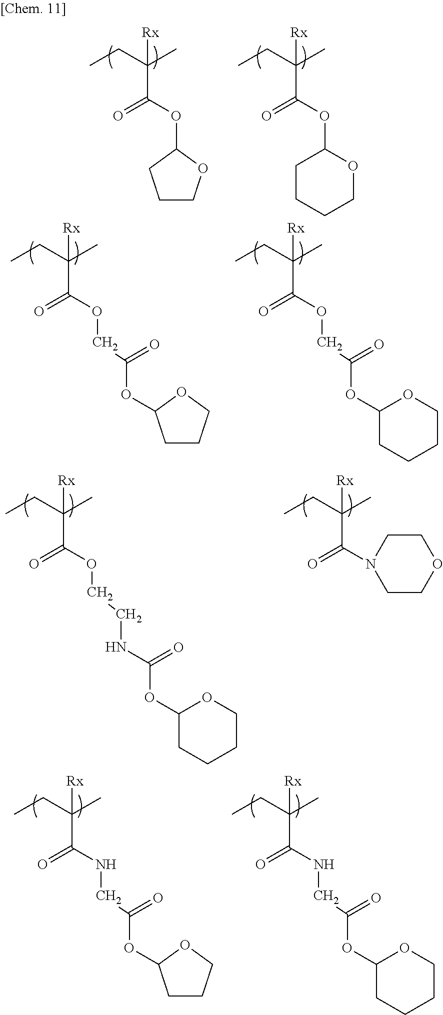

In the above formulae, Rx represents H, CH₃, CH₂OH or CF₃.

The sultone structure for R² in the above general formula (2) is preferably a 5- to 7-membered sultone structure. Preferably, the 5- to 7-membered sultone structure is condensed with any other cyclic structure to form a bicyclo structure or a spiro structure.

Specific examples of the repeating unit represented by the above general formula (2) where R² is a group having a sultone structure are shown below, to which, however, the present invention is not limited thereto.

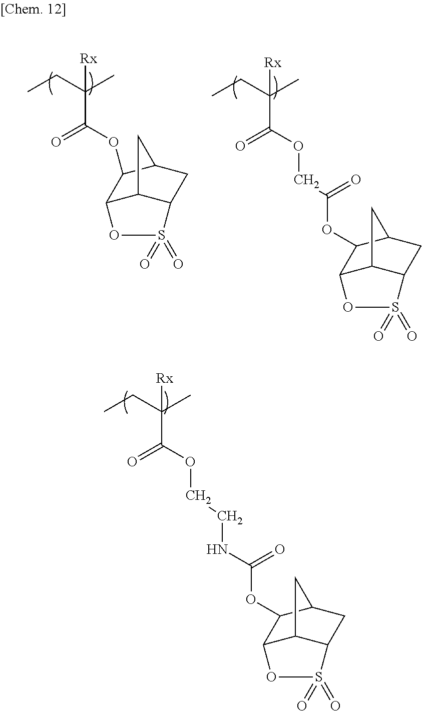

In the above formulae, Rx represents H, CH₃, CH₂OH or CF₃.

The repeating unit having a lactone structure or a sultone structure generally includes optical isomers, and any optical isomer may be used here. One optical isomer alone may be used, or plural optical isomers may be used as combined. In case where one optical isomer is used mainly, preferably the optical purity (ee) thereof is 90% or more, more preferably 95% or more.

The alkyl group having 3 or less carbon atoms for R² in the above general formula (2) includes a methyl group, an ethyl group, an n-propyl group, an i-propyl group and a cyclopropyl group.

Above all, the block having a repeating unit represented by the above general formula (2) where R² is a group having a lactone structure, a group having a sultone structure of a cyclic hydrocarbon group having an ether bond is preferred, as compared with the block having a repeated unit represented by the above general formula (1), in that (1) the selective removability is bettered in etching for patterning since the block has an oxygen atom, (2) as having a suitably high polarity, the block provides microphase separability sufficient for self-organization, and (3) copolymer chain mobility in annealing can be increased and therefore the time necessary for orientation in self-organization or for microphase separation can be further shortened since the interaction between the repeating units is small.

Preferably, the block copolymer for use in the present invention further has a block having a repeating unit with an alkylene oxide chain or an aliphatic ester chain as the main chain thereof.

Preferred examples of the repeating unit with an alkylene oxide chain or an aliphatic ester chain as the main chain thereof include a repeating unit with an ethylene oxide chain as the main chain structure thereof, a repeating unit with a propylene oxide chain as the main chain structure thereof, a repeating unit with a butylene oxide chain as the main chain structure thereof, and a repeating unit with a lactate chain as the main chain structure thereof.

The block copolymer in the present invention may further contain a block of any other repeating unit.

The other repeating unit includes, for example, a repeating unit with a siloxane bond as the main chain structure thereof. Concretely, the repeating unit with a siloxane unit as the main chain structure thereof includes a repeating unit with dimethylsiloxane as the main chain structure thereof, a repeating unit with diethylsiloxane as the main chain structure thereof, a repeating unit with diphenylsiloxane as the main chain structure thereof, and a repeating unit with methylphenylsiloxane as the main chain structure thereof.

In the present invention, the shape and the size of the phase to be selectively removed in resist patterning can be controlled by the degree of polymerization and the molecular weight of the block to constitute the block copolymer (hereinafter this may be referred to as “segment”). For example, when the ratio of the components of segments is kept on the same level, then a lamella structure may be formed, or when the content (by mass) of one segment relative to the entire mass of the block copolymer is relatively reduced, then a cylinder structure may be formed.

In case where the structure to be formed through self-organization of a block copolymer is a lamella structure (where the pattern to be formed is, for example, a line pattern), it is desirable that the ratio of the components of segments is such that the ratio by mass of the block to be removed through etching in resist patterning to the block to remain is from 30/70 to 70/30. In case where the structure to be formed through self-organization of a block copolymer is a cylinder structure (where the pattern to be formed is, for example, a dot pattern), it is desirable that the ratio of the components of segments (by mass) is from 10/90 to 70/30. From this, it is desirable that the content of the block having a repeating unit represented by the above general formula (1) is from 30 to 90% by mass relative to the total mass of the block copolymer, more preferably from 40 to 80% by mass.

In case where the block copolymer further has a block that contains a repeating unit represented by the above-mentioned general formula (2), the content of the block having the repeating unit represented by the general formula (2) is preferably from 10 to 70% by mass relative to the total mass of the block copolymer, more preferably from 20 to 60% by mass.

In case where the block copolymer further contains a block that has a repeating unit with the above-mentioned alkylene oxide chain or aliphatic ester chain as the main chain structure thereof, or a block comprising any other above-mentioned repeating unit, the content of the block having a repeating unit with the above-mentioned alkylene oxide chain or aliphatic ester chain as the main chain structure thereof, or the block comprising any other above-mentioned repeating unit is preferably from 10 to 70% by mass relative to the total mass of the block copolymer, more preferably from 20 to 60% by mass.

Increasing the weight-average molecular weight of the block copolymer may increase the size of each phase.

Synthesis of the block copolymer is not specifically defined, for which, however, preferred is use of a living anionic polymerization method or a living radical polymerization method.

In particular, for synthesis of the block copolymer having a functional group capable of terminating anionic polymerization such as a hydroxyl group or the like as the repeating unit therein, preferred is use of a living radical polymerization.

Not specifically defined, the mass-average molecular weight (Mw) of the block copolymer (equivalent to polystyrene in gel permeation chromatography) may be any one capable of providing microphase separation, but is preferably from 5000 to 500000, more preferably from 10000 to 200000, even more preferably from 20000 to 100000.

The dispersion degree (Mw/Mn) of the block copolymer is preferably from 1.0 to 3.0, more preferably from 1.0 to 1.5, even more preferably from 1.0 to 1.3. Mn means the number-average molecular weight of the block copolymer.

Specific examples of a combination (binary) of repeating units to constitute a block in the block copolymer that is contained in the self-organizing composition for patterning of the present invention are shown below, to which, however, the present invention is not limited thereto.

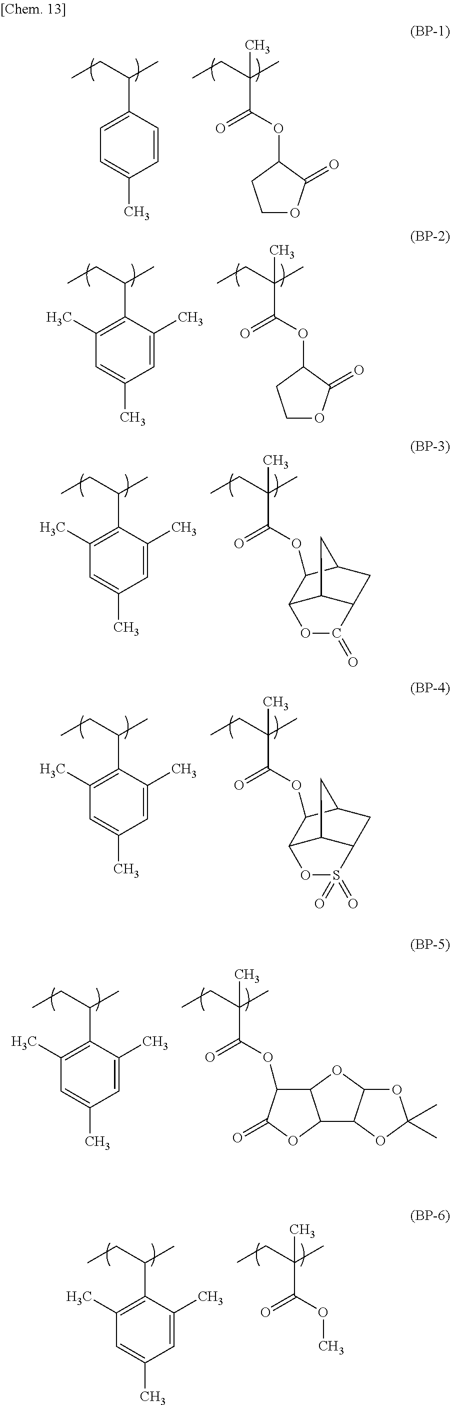

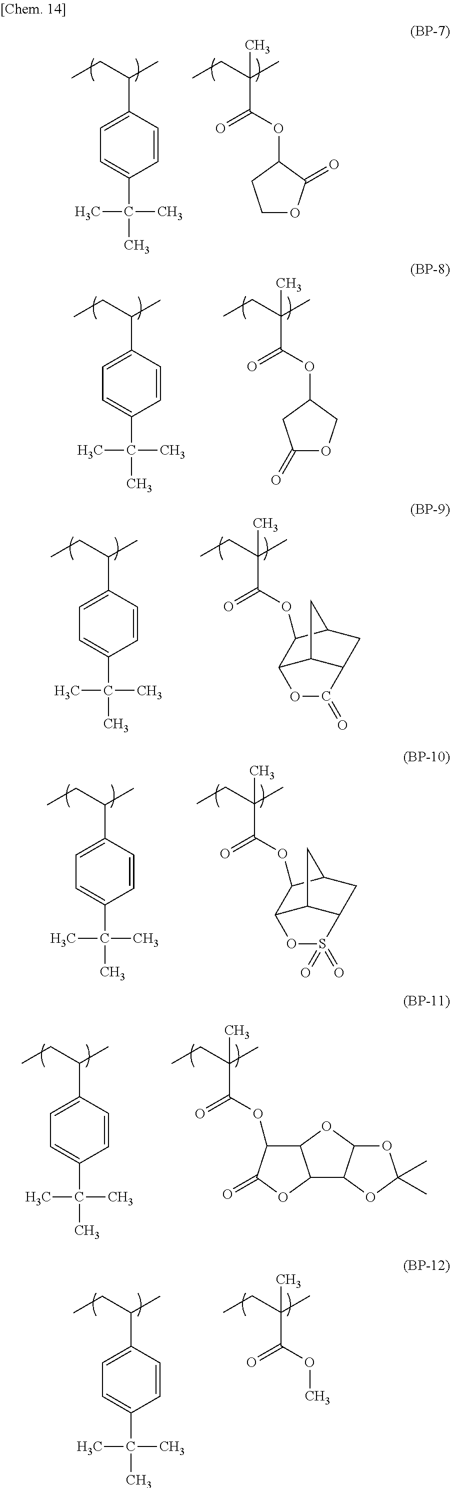

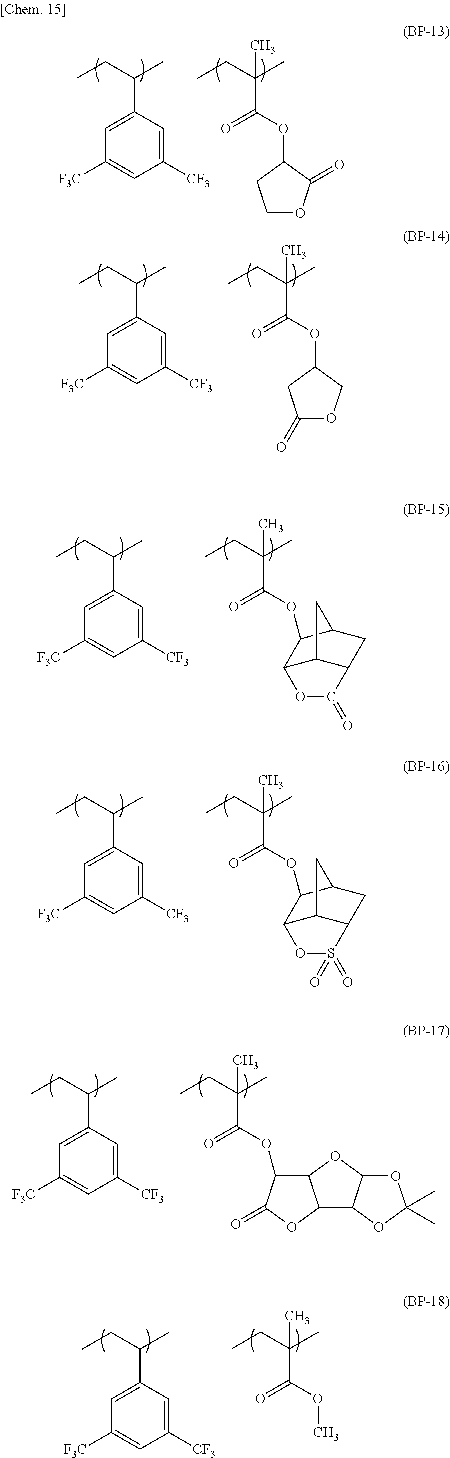

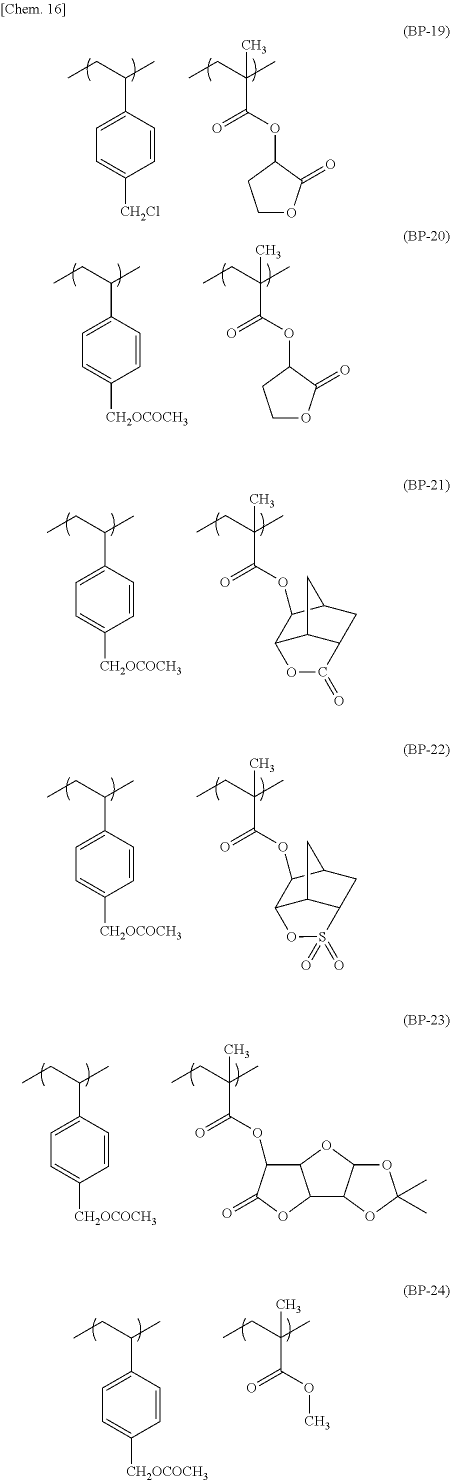

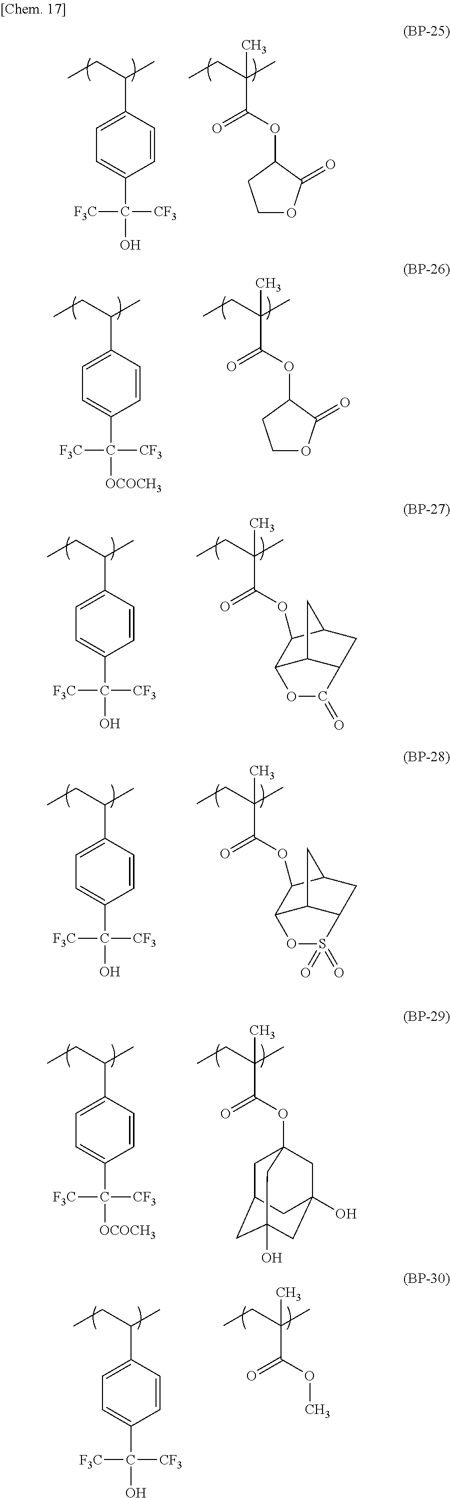

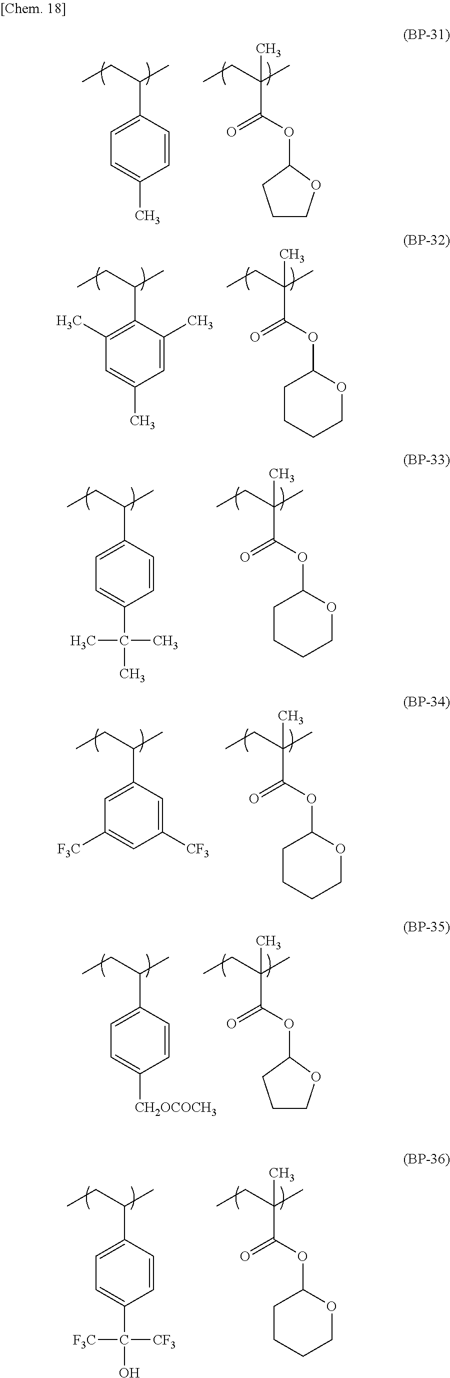

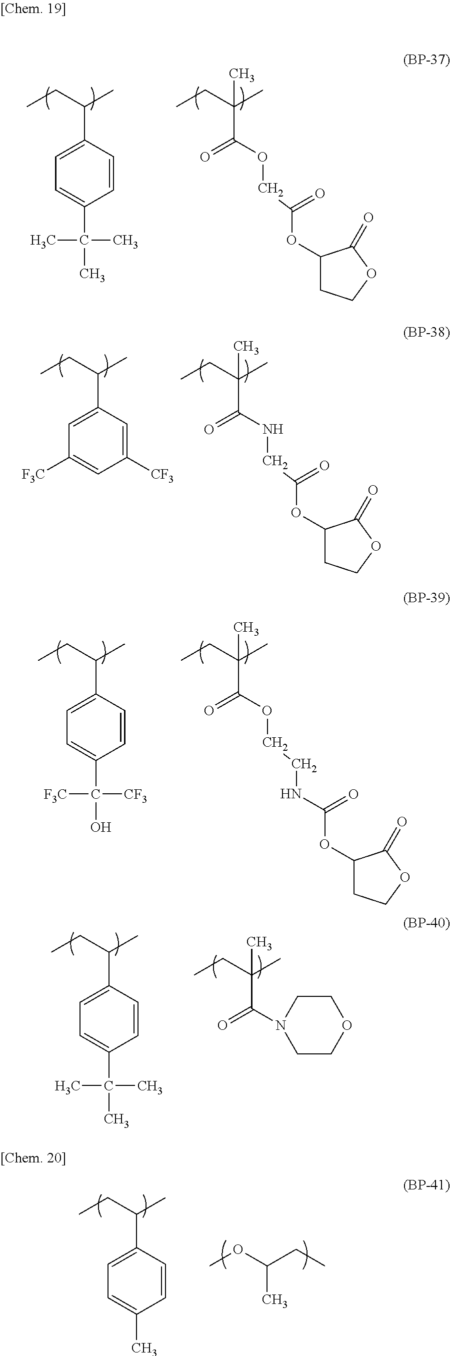

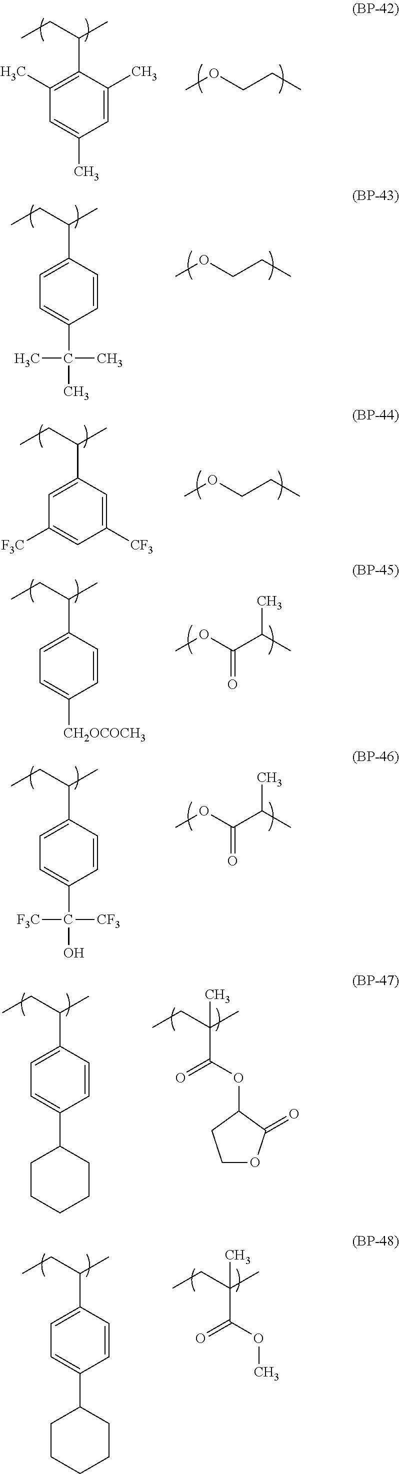

Specific examples of a combination (ternary) of repeating units to constitute a block in the block copolymer that is contained in the self-organizing composition for patterning of the present invention are shown below, to which, however, the present invention is not limited. Three repeating units shown in the following structures each independently constitute a block.

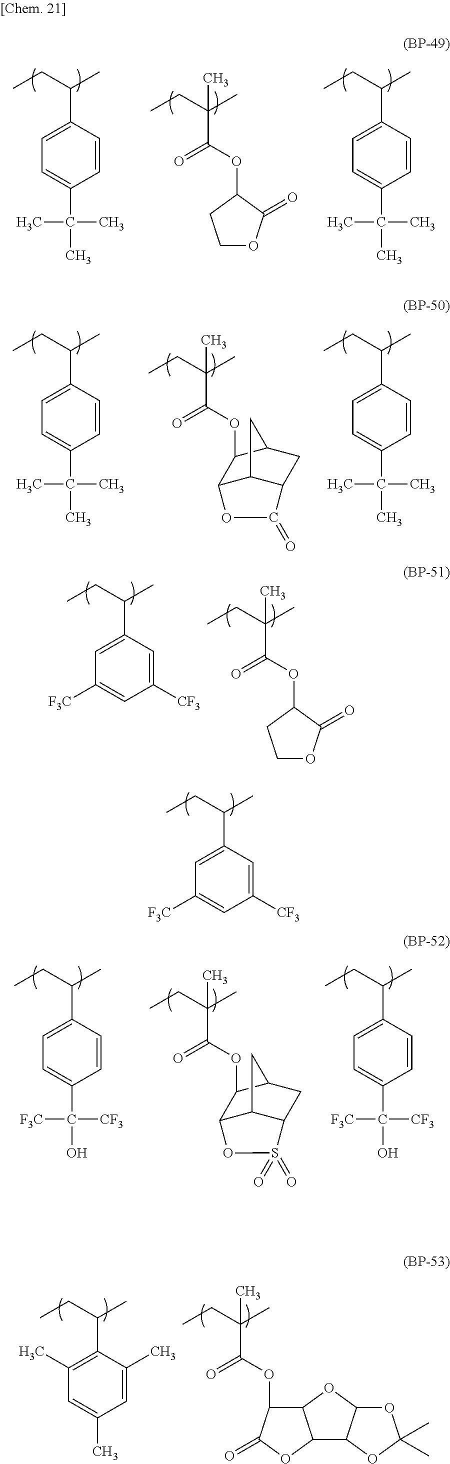

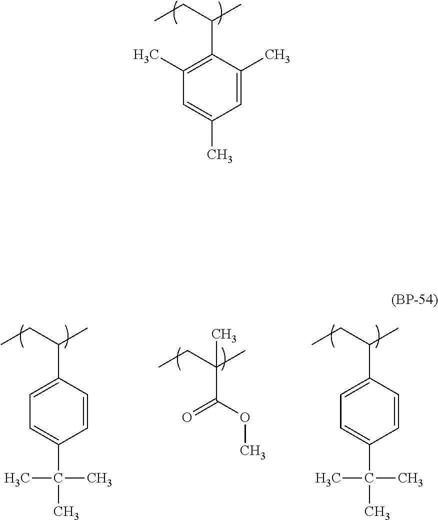

Not specifically defined, the organic solvent to be contained in the self-organizing composition for forming pattern for the present invention may be any one capable of dissolving the block copolymer sued to give a uniform solution. Preferred is one that is highly miscible with any of the polymers constituting the block copolymer. One alone or two or more different types of organic solvents may be used here either singly or as a mixed solvent.

The organic solvent for dissolving the block copolymer includes, for example, alkylene glycol monoalkyl ether carboxylates, alkylene glycol monoalkyl ethers, alkyl lactates, alkyl alkoxypropionates, cyclic lactones (preferably having from 4 to 10 carbon atoms), monoketone compounds optionally having a ring (preferably having from 4 to 10 carbon atoms), alkylene carbonates, alkoxyalkyl acetates, alkyl pyruvates, aromatic organic solvents, etc.

Preferred examples of the alkylene glycol monoalkyl ether carboxylates include, for example, propylene glycol monomethyl ether acetate, propylene glycol monoethyl ether acetate, propylene glycol monopropyl ether acetate, propylene glycol monobutyl ether acetate, propylene glycol monomethyl ether propionate, propylene glycol monoethyl ether propionate, ethylene glycol monomethyl ether acetate, ethylene glycol mono ethyl ether acetate.

Preferred examples of the alkylene glycol monoalkyl ethers include, for example, propylene glycol monomethyl ether, propylene glycol monoethyl ether, propylene glycol monopropyl ether, propylene glycol monobutyl ether, ethylene glycol monomethyl ether, ethylene glycol monoethyl ether.

Preferred examples of the alkyl lactates include, for example, methyl lactate, ethyl lactate, propyl lactate, butyl lactate.

Preferred examples of the alkyl alkoxypropionates include, for example, ethyl 3-ethoxypropionate, methyl 3-methoxypropionate, methyl 3-ethoxypropionate, ethyl 3-methoxypropionate.

Preferred examples of the cyclic lactones include, for example, β-propiolactone, β-butyrolactone, γ-butyrolactone, α-methyl-γ-butyrolactone, β-methyl-γ-butyrolactone, γ-valerolactone, γ-caprolactone, γ-octanoic lactone, α-hydroxy-γ-butyrolactone.

Preferred examples of the monoketone compounds optionally having a ring include, for example, 2-butanone, 3-methylbutanone, pinacolone, 2-pentanone, 3-pentanone, 3-methyl-2-pentanone, 4-methyl-2-pentanone, 2-methyl-3-pentanone, 4,4-dimethyl-2-pentanone, 2,4-dimethyl-3-pentanone, 2,2,4,4-tetramethyl-3-pentanone, 2-hexanone, 3-hexanone, 5-methyl-3-hexanone, 2-heptanone, 3-heptanone, 4-heptanone, 2-methyl-3-heptanone, 5-methyl-3-heptanone, 2,6-dimethyl-4-heptanone, 2-octanone, 3-octanone, 2-nonanone, 3-nonanone, 5-nonanone, 2-decanone, 3-decanone, 4-decanone, 5-hexen-2-one, 3-penten-2-one, cyclopentanone, 2-methylcyclopentanone, 3-methylcyclopentanone, 2,2-dimethylcyclopentanone, 2,4,4-trimethylcyclopentanone, cyclohexanone, 3-methylcyclohexnaone, 4-methylcyclohexanone, 4-ethylcyclohexanone, 2,2-dimethylcyclohexanone, 2,6-dimethylcyclohexanone, 2,2,6-trimethylcyclohexnaone, cycloheptanone, 2-methylcycloheptanone, 3-methylcycloheptanone.

Preferred examples of the alkylene carbonates include, for example, propylene carbonate, vinylene carbonate, ethylene carbonate, butylene carbonate.

Preferred examples of the alkoxyalkyl acetates include, for example 2-methoxyethyl acetate, 2-ethoxyethyl acetate, 2-(2-ethoxyethoxyl)ethyl acetate, 3-methoxy-3-methylbutyl acetate, 1-methoxy-2-propyl acetate.

Preferred examples of the alkyl pyruvates include, for example, methyl pyruvate, ethyl pyruvate, propyl pyruvate.

Preferred examples of the aromatic organic solvents include toluene, xylene, cymene, mesitylene, as well as oxygen atom-containing anisole, diphenyl ether, ethylbenzyl ether, benzyl alcohol, etc.

Solvents having a boiling point of not lower than 130° C. at room temperature and under normal pressure are preferred for use herein. Concretely, there are mentioned cyclopentanone, γ-butyrolactone, cyclohexanone, ethyl acetate, ethylene glycol monoethyl ether acetate, propylene glycol monomethyl ether acetate, ethyl 3-ethoxypropionate, ethyl pyruvate, 2-ethoxyethyl acetate, 2-(2-ethoxyethoxyl)ethyl acetate, propylene carbonate.

In the present invention, one alone or two or more types of the above-mentioned solvents may be used either singly or as combined. Preferred is use of a mixed solvent of two or more including propylene glycol monomethyl ether acetate. The solvent to be mixed with propylene glycol monomethyl ether acetate is preferably one having a higher boiling point than that of propylene glycol monomethyl ether acetate, and for example, preferred are toluene, anisole, γ-butyrolactone, ethyl acetate, propylene carbonate, N-methylpyrrolidone, N,N-dimethylacetamide, dimethyl sulfoxide.

In the present invention, the thickness of the self-organizing resist film containing a block copolymer may be one that is sufficient for triggering microphase separation. Not specifically defined, the lower limit of the thickness is preferably from 10 nm to 100 nm, more preferably from 20 nm to 50 nm in consideration of the uniformity of the resultant microphase-separated structure and the etching resistance of the resist. Consequently, the content of the block copolymer in the self-organizing composition for patterning of the present invention is preferably from 0.3 to 3% by mass, more preferably from 0.5 to 2.5% by mass, even more preferably from 1 to 2% by mass. With that, the uniformity of the coating surface in spin coating could be improved.

Similarly, the solid concentration of the self-organizing composition for forming pattern of the present invention is preferably from 0.05 to 3% by mass, more preferably from 0.1 to 2.5% by mass, even more preferably from 1 to 2% by mass.

Preferably, the self-organizing composition for forming pattern of the present invention further contains a surfactant. More preferably, the composition contains any one or more of fluorosurfactants and/or silicone surfactants (fluorosurfactants, silicone surfactants, surfactants containing both fluorine atom and silicon atom). The surfactant, if any, in the composition can shorten the annealing time. This is presumed because, when the self-organizing resist film is annealed, the formation of a horizontal alignment layer in the air interface could be reduced. As the fluorosurfactants and/or silicone surfactants, there are mentioned the surfactants described in [0276] in US Unexamined Patent Application Publication No. 2008/0248425, including, for example, Eftop EF301, EF303 (by Shin-Akita Chemical), Fluorad FC430, 431, 4430 (by Sumitomo 3M), Megafac F171, F173, F176, F189, F113, F110, F177, F120, R08 (by DIC), Surflon S-382, SC101, 102, 103, 104, 105, 106 (by Asahi Glass), Troysol S-366 (by Troy Chemical), GF-300, GF-150 (by Toa Gosei Chemical), Surflon S-393 (by Seimi Chemical), Eftop EF121, EF122A, EF122B, RF122C, EF125M, EF135M, EF351, EF352, EF801, EF802, EF601 (by Gemco), PF636, PF656, PF6320, PF6520 (by OMNOVA), FTX-204G, 208G, 218G, 230G, 204D, 208D, 212D, 218D, 222D (by Neos), etc. In addition, polysiloxane polymer KP-341 (by Shin-Etsu Chemical Industry) can also be used as a silicone surfactant here.

In addition to the above-mentioned known ones, other surfactants are also usable here, including, for example, surfactants using a fluoroaliphatic group-having polymer derived from a fluoroaliphatic compound produced according to a telomerization method (also referred to as a telomer method) or an oligomerization method (also referred to as an oligomer method). The fluoroaliphatic compound may be produced according to the method described in JP-A 2002-90991. The surfactants corresponding to the above include Megafac F178, F-470, F-473, F475, F-476, F-472 (by DIC), copolymer of C₆F₁₃-having acrylate (or methacrylate) and (poly(oxyalkylene)) acrylate (or methacrylate), copolymer of C₃F₇-having acrylate (or methacrylate) and (poly(oxyethylene)) acrylate (or methacrylate) and (poly(oxypropylene)) acrylate (or methacrylate), etc. In addition, in the present invention, also usable are any other surfactants than fluorosurfactants and/or silicone surfactants, such as those described in [0280] in US Unexamined Patent Application Publication No. 2008/0248425.

One alone or two or more of these surfactants may be used either singly or as combined.

In case where the self-organizing composition for patterning of the present invention contains a surfactant, the amount of the surfactant therein is preferably from 1 to 1000 ppm relative to the total solid content in the self-organizing composition for patterning of the present invention, more preferably from 1 to 100 ppm. When the amount of the surfactant is controlled to be at most 1000 ppm, then the surfactant can be prevented from having any negative influence on patterning through self-organization.

Next described is a method for patterning through self-organization of the block copolymer in the present invention.

The substrate to be used in the method for patterning through self-organization of the block copolymer in the present invention is, for example, a metal such as silicon wafer, aluminium, iron, etc., glass, quartz; a polymer film of polyethylene terephthalate, cellulose acetate, polyethylene, polypropylene, etc. The surface of the substrate may be washed before a self-organizing resist film containing a block copolymer is formed thereon. The washing treatment includes oxygen plasma treatment, ozone oxidation treatment, acid alkali treatment, chemical modification treatment, etc. For example, a substrate is immersed in an acid solution such as a sulfuric acid/hydrogen peroxide solution or the like, then rinsed with water and dried.

Subsequently, it is desirable that the surface of the substrate is modified through neutralization so as to have affinity with every block constituting the block copolymer. Concretely, it is desirable that a neutralized film that contains a surfacing agent having an affinity with every block constituting the block copolymer is formed on the surface of the substrate.

The neutralized film includes, for example, a film that contains, as a surfacing agent therein, a resin containing every repeating unit contained in each block constituting the block copolymer, a film that contains, as a surfacing agent therein, a resin containing a repeating unit having a high affinity with each block constituting the block copolymer, an antireflection film for use in photolithography (BARC), etc.

In the present invention, it is desirable that a guide pattern is provided on the surface of the neutralized film to be a surfacing layer thereon, before the self-organizing composition for patterning is applied onto the film. This can make it possible to control the alignment or the configuration of the microphase-separated structure in accordance with the profile and the surface characteristics of the guide pattern.

Grooves may be formed in the surface of the neutralized film according to a lithography method or an imprinting method so as to be used as a guide pattern. This is referred to as a graphoepitaxy method, in which, for example, a film of a resist composition having affinity with any block constituting the block copolymer is formed on the surface of the neutralized film containing a surfacing agent, then patternwise exposed with radiations such as light, electron beams or the like, and developed to form a guide pattern. The resist composition of the type may be any of a positive resist composition or a negative resist composition, but is preferably a negative resist composition. As the negative resist composition, usable here is any of a negative development resist in which the acid-decomposing resin in the exposed area is deprotected and the solubility thereof in an organic development developer to form an image, or a negative resist in which the resin in the exposed area is crosslinked and the solubility thereof in an alkali developer or an organic solvent developer is lowered. Here after an organic solvent solution of the block copolymer has been applied, this is annealed under heat or with a solvent, and therefore preferred is one capable of forming a resist film excellent in heat resistance and solvent resistance.

In the present invention, a guide pattern that a region having affinity with any block constituting the block copolymer and any other region may be formed on the surface of a substrate. This is a chemical registration method, in which, concretely, an undercoat layer is formed on the surface of a substrate, then patternwise exposed with radiations such as light, electron beams or the like via a mask, and then developed to thereby form a pattern having affinity with any block constituting the block copolymer on the surface of the substrate.

For the undercoat layer for chemical registration, preferred is a negative photosensitive resin composition, a thermal-polymerizing resin composition, a chemical-amplifying positive resist composition or a novolak resist composition. Preferably, these compositions contain a compound having a group capable of expressing adhesiveness to the substrate. As the group capable of expressing adhesiveness, preferred are a phenolic hydroxyl group, a carboxyl group, a thiol group, an amino group, an amide group, an isocyanate group, a nitro group, an epoxy group, an oxetanyl group, a (meth)acryloyl group and an alkoxysilane.

### (Annealing Step)

Next described is formation of a microphase-separated structure of a layer that contains a block copolymer, by an annealing step.

A composition containing a block copolymer dissolved in a suitable organic solvent is applied onto the surface of a substrate using a spinner or the like, so that a self-organizing resist film containing the block copolymer is formed on the surface of the substrate. Subsequently, the substrate with the self-organizing resist film containing the block copolymer formed thereon is annealed to promote the self-organization of the block copolymer to thereby form a microphase-separated structure such as a lamella structure, a dot structure, a cylinder structure, etc.

In case where the substrate is heated in the annealing step, the temperature is preferably not lower than the glass transition temperature (Tg) of the block copolymer used but lower than the thermal decomposition temperature thereof.

For example, it is desirable that the substrate is heated at 80 to 200° C., more preferably at 100 to 160° C.

According to the present invention, the heating time in the annealing step may be 60 minutes or less, and preferably 20 minutes or less. Accordingly, the throughput can be improved.

The heating treatment is preferably carried out in a poorly-reactive gas such as nitrogen, etc.

### (Post-Process)

Finally, after the microphase-separated structure has been formed, any one domain (domain comprising a specific block) is selectively removed to form a pattern (line-and-space pattern, dot patter, etc.), whereby at least a part of the surface of the substrate can be exposed out. Not specifically defined, such selective removal treatment may be any one that does not have any influence on the remaining domain but can preferentially decompose and remove the domain to be removed. For example, there are mentioned chemical treatment and thermal decomposition treatment such as oxygen plasma treatment, ozone treatment and UV irradiation treatment.

In addition, the present invention also relates to a method for producing an electronic device including the pattern forming method through self-organization of the block copolymer of the present invention mentioned above, and the electronic device produced according to the production method.

The electronic device of the present invention is favorably mounted on electric and electronic appliances (home electric appliances, OA/media-related appliances, optical appliances, communication appliances and the like). For example, there are further mentioned stampers and the like for bit patterned media for hard disc drives.

### EXAMPLES

The present invention is described more concretely with reference to the following Examples, to which, however, the contents of the present invention are not limited thereto.

### Synthesis Example 1

### Synthesis of Block Copolymer Represented by Structure (BP-7)

Cumyl dithiobenzoate (1.6 g), azobisisobutyronitrile (530 mg) and γ-butyrolactone methacrylate (400 ml) were dissolved in toluene (130 ml), purged with nitrogen, and polymerized with heating and stirring at 60° C. for 4 hours to give a γ-butyrolactone methacrylate polymer having a thiobenzoyl group at the terminal thereof.

4-t-butylstyrene (100 ml) was added to the polymer (17 g) obtained in the above and azobisisobutyronitrile (30 mg), purged with nitrogen, and polymerized with heating and stirring at 60° C. for 4 hours to give a block copolymer corresponding to a block ratio (by mass)=49/51, a weight-average molecular weight of 35000 and a dispersion degree of 1.22 (yield 20%). The resultant polymer was dissolved in ethyl acetate and then washed with heptane through reprecipitation repeatedly three times, and this was used as a block copolymer having a weight-average molecular weight of 38000 and a dispersion degree of 1.15, for evaluation of self-organization patterning.

Similarly to the block copolymer of (BP-7), block copolymers of (BP-1) to (BP-6), and (BP-8) to (BP-40), and block copolymers of Comparative Synthesis Examples 1 and 2 were produced.

### Synthesis Example 15

### Synthesis of Block Copolymer Represented by Structure (BP-43)

A THF solution of sodium hydroxide (1.7 g, 42 mmol) and 4-hydroxy-TEMPO (5.6 g) was put in a reactor and heated under reflux for 24 hours. To this, a THF solution of monomethoxypolyethylene glycol tosylated at the terminal thereof with p-toluenesulfonic acid chloride (molecular weight 6000) was dropwise added, and further refluxed with stirring for 24 hours to give a monomethoxypolyethylene glycol with TEMPO introduced at the terminal thereof. To the resultant TEMPO-terminated monomethoxypolyethylene glycol, added were 4-t-butylstyrene (188 g) and benzoyl peroxide (20 mg), and polymerized with heating and stirring at 125° C. for 14 hours. The resultant polymer was dissolved in ethyl acetate, and washed with heptane through reprecipitation repeatedly three times to give a block copolymer having a weight-average molecular weight of 30000 and a dispersion degree of 1.18 (yield 15%).

Block copolymers (BP-41) to (BP-42) and block copolymers of (BP-44) to (BP-46) were also produced in the same manner as above using 4-hydroxy-TEMPO.

TABLE 1

| | | | Weight- | |
|---|---|---|---|---|
| | Structure | Block | Average | |
| | of Block | Ratio | Molecular | Dispersion |
| | Copolymer | (by mass) | Weight | Degree |
| Synthesis Example 1 | (BP-7) | 49/51 | 38000 | 1.15 |
| Synthesis Example 2 | (BP-17) | 74/26 | 32000 | 1.19 |
| Synthesis Example 3 | (BP-2) | 48/52 | 35000 | 1.25 |
| Synthesis Example 4 | (BP-3) | 50/50 | 34000 | 1.23 |
| Synthesis Example 5 | (BP-10) | 49/51 | 29000 | 1.24 |
| Synthesis Example 6 | (BP-19) | 48/52 | 35000 | 1.25 |
| Synthesis Example 7 | (BP-25) | 49/51 | 34000 | 1.22 |
| Synthesis Example 8 | (BP-33) | 48/52 | 36000 | 1.25 |
| Synthesis Example 9 | (BP-6) | 73/27 | 42000 | 1.19 |
| Synthesis Example 10 | (BP-12) | 76/24 | 35000 | 1.20 |
| Synthesis Example 11 | (BP-30) | 74/26 | 36000 | 1.27 |
| Synthesis Example 12 | (BP-34) | 79/21 | 53000 | 1.23 |
| Synthesis Example 13 | (BP-38) | 72/28 | 37000 | 1.24 |
| Synthesis Example 14 | (BP-40) | 74/26 | 35000 | 1.20 |
| Synthesis Example 15 | (BP-43) | 80/20 | 30000 | 1.18 |
| Synthesis Example 16 | (BP-44) | 48/52 | 29000 | 1.24 |
| Synthesis Example 17 | (BP-47) | 76/24 | 35000 | 1.09 |
| Synthesis Example 18 | (BP-49) | 38/24/38 | 42000 | 1.29 |
| Comparative Synthesis | (BPC-1) | 50/50 | 32000 | 1.22 |
| Example 1 | | | | |
| Comparative Synthesis | (BPC-2) | 75/25 | 32000 | 1.19 |
| Example 2 | | | | |

In the above Table, the structures of the block copolymers are as shown above.

(BPC-1) and (BPC-2) are polystyrene-polymethyl methacrylate block copolymers shown below (the block ratio is shown in the above Table.)

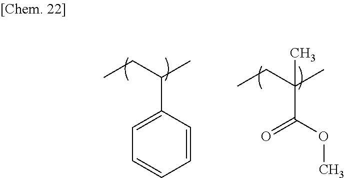

### Example 1

### Evaluation of Line Patterning

On a 12-inch silicon wafer, an organic antireflection film ARC29SR (by Nissan Chemical) was provided by coating and baked at 205° C. for 60 seconds to form an antireflection film having a thickness of 78 nm. On this, a positive ArF excimer laser exposure immersion resist FAiR-D04 (by Fujifilm Electronics Materials) was applied by spin coating while the rotation number was so controlled that the thickness of the film to be formed thereon could be 100 nm, and baked at 120° C. for 60 seconds.

Next, using an ArF excimer laser immersion scanner (ASML's XT1700i, NA 1.20), this was photoexposed via a 6-% half-tone mask having a 1/1 line-and-space pattern with a line width of 90 rim, then baked at 110° C. for 60 seconds, and thereafter developed with an aqueous solution of 2.38 mass % tetramethylammonium hydroxide (TMAH) to form a graphoepitaxial guide pattern (1/1 line-and-space with line width of 90 nm). Ultra-pure water was used as the immersion liquid.

A solution of the block copolymer (0.15 g) of (BP-7) of Synthesis Example 1 dissolved in propylene glycol monomethyl ether acetate (100 g) was filtered through a polyethylene filter having a pore size of 0.05 μm to prepare a self-organizing resist solution. This was applied onto the substrate with the guide pattern formed thereon by spin-coating (rotation number: 2000 rpm, 60 seconds), and then heated and dried at 110° C. for 60 seconds to form a self-organizing resist film having a thickness of 35 nm.

Next, in a nitrogen stream atmosphere, this was annealed for a varying period of 1 minute, 5 minutes, 10 minutes, 25 minutes, 30 minutes, 45 minutes, 60 minutes, 120 minutes or 180 minutes to prepare samples.

Subsequently, the microphase-separated structure of the surface of the resultant substrate was observed with a scanning electronic microscope 54800 (by Hitachi), and the annealing time necessary for realizing a line pattern of a regular lamella pattern with lines parallel to each other was determined.

### Examples 2 to 11, and Comparative Example 1

In Examples 2 to 11 and Comparative Example 1, which were the same as Example 1 except that the coating solvent and the surfactant were changed as in the following Table, the annealing time necessary for forming a regular lamella pattern was measured and the samples were evaluated also in the same manner as in Example 1.

The results are shown in the following Table 2.

### Example 12

### Evaluation of Dot Patterning Form

On a 12-inch silicon wafer, a propylene glycol monomethyl ether acetate solution of a hydroxyl-terminated polystyrene (weight-average molecular weight 32000; by Polymer Source) (2 mass % solution) was applied, and heated at 160° C. for 3 hours. The surface was rinsed with butyl acetate, and a positive electron beam resist FEP-171 (Fujifilm Electronics Materials' product) was applied thereto so as to form a film thereon having a thickness of 100 nm, then baked at 120° C. for 60 seconds, and using an electron beam patterning device (Hitachi's HL750, acceleration voltage 50 KeV), this was photoexposed to form a dot pattern having a pitch of 55 nm and a dot diameter of 27.5 nm. After the irradiation, this was heated on a hot plate at 120° C. for 90 seconds, then immersed in an aqueous solution of 2.38 mass % tetramethylammonium hydroxide (TMAH) for 60 seconds, and thereafter rinsed with water for 30 seconds and dried. Through oxygen plasma etching treatment, the polystyrene layer on the surface of the substrate was removed by ashing, and the electron beam resist was removed with a resist peeler ER-6 (Fujifilm Electronics Materials' product) to form, on the substrate, a guide pattern of chemical registration.

A solution of the block copolymer (0.15 g) of (BP-17) of Synthesis Example 2 dissolved in propylene glycol monomethyl ether acetate/γ-butyrolactone (97 g/3 g) was applied onto the substrate with the guide pattern formed thereon by spin-coating (rotation number: 1000 rpm, 60 seconds), and then heated and dried at 110° C. for 60 seconds to form a self-organizing resist film having a thickness of 40 nm.

Next, in a nitrogen stream atmosphere, this was annealed (at 160° C.) for a varying period of 1 minute, 5 minutes, 10 minutes, 15 minutes, 20 minutes, 25 minutes, 30 minutes, 45 minutes, 60 minutes, 120 minutes or 180 minutes to prepare samples. Next, these were subjected to oxygen plasma treatment, and the microphase-separated structure of the surface of the resultant substrate was observed with a scanning electronic microscope S4800 (by Hitachi), and the annealing time necessary for realizing a regular dot pattern was determined.

### Examples 13 to 21, and Comparative Example 2

In Examples 13 to 21 and Comparative Example 2, which were the same as Example 12 except that the block copolymer, the coating solvent and the surfactant were changed as in the following Table, the annealing time necessary for forming a regular dot pattern was measured and the samples were evaluated also in the same manner as in Example 12.

The results are shown in the following Table 2.

TABLE 2

| | | | | | Annealing |
|---|---|---|---|---|---|
| | | | | | Time |
| | | | | | Necessary for |
| | | | | | Microphase |
| Composition | Block Copolymer | Coating Solvent | | | Separation |
| No. | (0.15 g) | (100 g) | Surfactant | Pattern | (regulation) |
| Example 1 | Synthesis Example 1 | PGMEA | | line | 30 min |
| Example 2 | Synthesis Example 1 | PGMEA/γ-BL | | line | 25 min |
| | | (mass ratio 97/3) | | | |
| Example 3 | Synthesis Example 4 | PGMEA/γ-BL | | line | 25 min |
| | | (mass ratio 97/3) | | | |
| Example 4 | Synthesis Example 5 | toluene | | line | 25 min |
| Example 5 | Synthesis Example 10 | PGMEA | | line | 45 min |
| Example 6 | Synthesis Example 7 | anisole | | line | 25 min |
| Example 7 | Synthesis Example 8 | PGMEA/toluene | | line | 30 min |
| | | (mass ratio 80/20) | | | |
| Example 8 | Synthesis Example 16 | PGMEA | | line | 30 min |
| Example 9 | Synthesis Example 1 | PGMEA | W-1 (100 ppm) | line | 25 min |
| Example 10 | Synthesis Example 1 | PGMEA | W-2 (100 ppm) | line | 25 min |
| Example 11 | Synthesis Example 1 | PGMEA | W-3 (100 ppm) | line | 25 min |
| Comparative | Comparative Synthesis | PGMEA | | line | 180 min or |
| Example 1 | Example 1 | | | | more |
| Example 12 | Synthesis Example 2 | PGMEA/γ-BL | | dot | 20 min |
| | | (mass ratio 97/3) | | | |
| Example 13 | Synthesis Example 9 | PGMEA | | dot | 25 min |
| Example 14 | Synthesis Example 10 | PGMEA/PGME | | dot | 25 min |
| | | (mass ratio 80/20) | | | |
| Example 15 | Synthesis Example 11 | PGMEA | | dot | 25 min |
| Example 16 | Synthesis Example 12 | PGMEA | | dot | 20 min |
| Example 17 | Synthesis Example 13 | PGMEAIPGME | | dot | 20 min |
| | | (mass ratio 80/20) | | | |
| Example 18 | Synthesis Example 14 | PGMEA/γ-BL | | dot | 20 min |
| | | (mass ratio 97/3) | | | |
| Example 19 | Synthesis Example 15 | PGMEA | | dot | 20 min |
| Example 20 | Synthesis Example 17 | PGMEA | | dot | 20 min |
| Example 21 | Synthesis Example 18 | toluene | | dot | 20 min |
| Comparative | Comparative Synthesis | PGMEA | | dot | 180 min or |
| Example 2 | Example 2 | | | | more |

The unit ppm of the amount used of the surfactant is ppm relative to the total solid content of the composition.

Abbreviations in the above Table are as follows.

PGMEA: propylene glycol monomethyl ether acetate
PGME: propylene glycol monomethyl ether
γ-BL: γ-butyrolactone
W-1: Megafac F176 (by DIC) (fluorosurfactant)
W-2: Megafac R08 (by DIC) (fluorosurfactant and silicone surfactant)
W-3: PolyFox™ PF-6320 (by OMNOVA Solution Inc.) (fluorosurfactant)

As obvious from the results shown in the above Table 2, it is known that Comparative Example 1 using a block copolymer of unsubstituted polystyrene and polymethyl methacrylate required a long annealing time for regular lamella patterning, 180 minutes, and was poor in throughput.

On the other hand, it is known that Examples 1 to 11 using a block copolymer containing a block having a repeating unit represented by the general formula (1) in which styrene has a specific substituent all required a short annealing period of time of 45 minutes or less necessary for regular lamella patterning, and were excellent in throughput.

In particular, it is known that Examples 1 to 4, 6 and 7 in which the block copolymer contains a block having a repeating unit represented by the general formula (2) and R² is a group having a lactone structure except an alkyl group having 3 or less carbon atoms, Example 8 in which the block copolymer contains a block having a repeating unit having, as the main chain thereof, an alkylene oxide chain or an aliphatic ester chain, and Examples 9 to 11 containing a surfactant required an extremely short period of annealing time necessary for regular lamella patterning and were especially excellent in throughput.

Similarly, it is known that Comparative Example 2 using a block copolymer of unsubstituted polystyrene and polymethyl methacrylate required a long period of annealing time of 180 minutes or more for regular dot patterning, and was poor in throughput.

On the other hand, it is known that Examples 12 to 21 using a block copolymer containing a block having a repeating unit represented by the general formula (1) in which styrene has a specific substituent all required a short annealing period of time of 25 minutes or less necessary for regular dot patterning, and were excellent in throughput.

In particular, it is known that Examples 12, 16 to 18, 20 and 21 in which the block copolymer contains a block having a repeating unit represented by the general formula (2) and R² is a group having a lactone structure except an alkyl group having 3 or less carbon atoms, and Example 19 in which the block copolymer contains a block having a repeating unit having, as the main chain thereof, an alkylene oxide chain or an aliphatic ester chain required an extremely short period of annealing time necessary for regular dot patterning and were especially excellent in throughput.

### INDUSTRIAL APPLICABILITY

The present invention provides a self-organizing composition for patterning, which can extremely shorten the annealing time necessary for microphase separation in self-organization lithography using a block copolymer and which can therefore improve the throughput in patterning, and provides a patterning method through self-organization of a block copolymer using the composition, and a pattern.

While the invention has been described in detail with reference to specific examples thereof, it will be apparent to one skilled in the art that various changes and modifications can be made therein without departing from the spirit and scope thereof.

The present application is based on a Japanese patent application filed on Sep. 28, 2012 (Application No. 2012-217567), the contents of which are incorporated herein by reference.

1. A pattern forming method through self-organization of a block copolymer, containing an annealing step after application of a self-organizing composition for forming pattern that contains a block copolymer containing a block having a repeating unit represented by the following general formula (1), and contains an organic solvent, to a substrate, and
wherein after a microphase-separated structure is formed in the annealing step, one domain thereof is selectively removed to form a pattern: 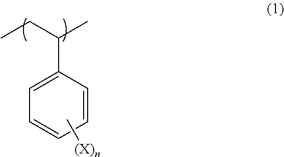
in the above general formula (1);
X represents an alkyl group or a cycloalkyl group;
n indicates an integer of from 1 to 5, and when n is 2 or more, X's may be the same or different.

2. The pattern forming method through self-organization of a block copolymer as claimed in claim 1,
wherein the block copolymer further contains a block having a repeating unit represented by the following general formula (2): 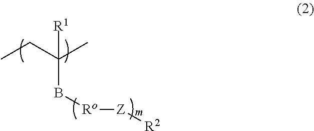
in the above general formula;
R¹ represents a hydrogen atom, a cyano group, a halogen atom or an alkyl group;
B represents an ester bond or an amide bond;
R⁰ or R⁰'s when a plurality of R⁰'s are present, each independently represent an alkylene group, a cycloalkylene group or a combination thereof;
Z or Z's when a plurality of Z's are present, each independently represent a single bond, an ether bond, an ester bond, an amide bond, an urethane bond or an urea bond;
m represents a repeating number of the structure represented by —R⁰—Z—, and indicates an integer of from 0 to 5; when m is 0, then the formula does not have —R⁰—Z— but has a single bond;
R² represents a group having a lactone structure, a group having a sultone structure, a cyclic hydrocarbon group having an ether bond, or an alkyl group having 3 or less carbon atoms.

3. The pattern forming method through self-organization of a block copolymer as claimed in claim 1,
wherein the block copolymer further contains a block having a repeating unit with an alkylene oxide chain or an aliphatic ester chain as the main chain thereof.

4. The pattern forming method through self-organization of a block copolymer as claimed in claim 1,
wherein the a self-organizing composition for forming pattern further contains a fluorosurfactant or a silicone surfactant.

5. The pattern forming method through self-organization of a block copolymer as claimed in claim 1,
wherein the substrate is a substrate wherein, on the surface thereof, an underlayer having a guide pattern that controls the alignment of the self-organization of the block copolymer is provided.

6. A pattern formed by the patterning method through self-organization of a block copolymer claimed in claim 1.

7. A method for producing an electronic device, containing the pattern forming method through self-organization of a block copolymer claimed in claim 1.

8. An electronic device produced by the method for producing an electronic device claimed in claim 7.
